(19) United States
(12) Patent Application Publication
(10) Pub. No.: US 2013/0328257 A1
(43) Pub. Date: Dec. 12, 2013

(54) LOG HOLDER AND LOG HOLDER ASSEMBLY

(71) Applicant: Andrew Martin, Whitley Bay (GB)

(72) Inventor: Andrew Martin, Whitley Bay (GB)

(73) Assignee: FOREST MASTER LTD, Whitley Bay, Tyne & Wear (GB)

(21) Appl. No.: 13/883,366

(22) PCT Filed: Oct. 19, 2011
(86) PCT No.: PCT/GB11/52018

§ 371 Date: May 3, 2013

(30) Foreign Application Priority Data
Nov. 5, 2010 (GB) 1018700.3
Mar. 30, 2011 (GB) 1105349.3

(51) Int. Cl. B27B 17/00; B25B 1/20

(52) U.S. Cl. CPC B27B 17/0075; B25B 1/205
USPC 269/97; 269/131

(57) ABSTRACT

A log holder for holding a log, tree or other piece of wood in a raised position above the ground to enable the log, tree or other piece of wood to be cut into pieces is disclosed. The log holder comprises a support member arranged to provide a fulcrum on which a log can be supported and about which the log can be pivoted. Stop means is provided and is adapted to adjustably secure strap means, the strap means being adapted to wrap in a loop around a log to hold the log in a cantilevered position between the strap means and the support member, wherein the stop means is adapted to enable the size of a loop of the strap means wrapped around a log resting on the support means to be decreased but not increased.

The present invention relates to a log holder and log holder assembly for holding a log, tree or other piece of wood in a raised position above the ground to enable the wood to be cut into pieces.

It is desirable to provide an apparatus to securely hold a log, felled tree or other piece of wood in a raised position to enable the log to be cut into pieces with a chainsaw or other cutting device. It is also desirable that such an apparatus is able to hold many different sizes of log, tree or piece of wood in a safe and secure manner.

EP1085966 describes a device for holding a log, felled tree or other pieces of wood. A plurality of upwardly pointing teeth is arranged on the lower part of a frame. A pendulum is pivotally mounted to the upper part of the frame and comprises a plurality of downwardly pointing teeth. In order to hold a log in a raised position, the log is rested on the upwardly pointing teeth and the pendulum is then pivoted to a position in which it grips the upper surface of the log. The log can then be lifted to a raised position in which it is cantilevered between the frame and the pendulum. This enables cutting of the log with a chain saw.

This apparatus suffers from the drawback that in order to change the size of log that can be held, the length of the pendulum must be adjusted. This is accomplished by removing the pendulum and then remounting it by passing two dowels through a different one of a plurality of sets of holes. Consequently, this apparatus is time consuming to adjust and comprises many moving parts which are prone to being misplaced or damaged. The apparatus of EP1085966 also suffers from the drawback that it is mounted on a heavy frame which can be difficult to transport.

The apparatus of EP1085966 suffers from the further drawback that the gap between the lower teeth and the horizontal beam or structure about which the pendulum pivots defines an upper size of log that can be held in the apparatus, because logs having a diameter greater than the size of this gap cannot fit in the gap.

In reality, the diameter of log that can be readily used in this apparatus is actually less than the gap width because in order to safely load a log in the gap, one end of the log is rested on the ground such that the log extends through the gap at an angle which decreases the size of log that can fit through the gap. For example, the apparatus defined by EP1085966 that is commercially available can generally hold a log having an upper width of 225 mm if the log is quite long. However, for short logs (e.g. less than 3 m in length), if one end of the log is rested on the ground for loading, the upper width limit that can fit in the gap is approximately 200 mm.

DEG8433785 describes a log holder having two V-shaped supports on which a log can be rested. A chain is mounted at one end to a spring which is attached to the frame of the log holder. A peg is provided at the other side of the supports from the chain so that the chain can be passed over a log and one of the links of the chain passed over peg to secure the chain over the log.

This apparatus suffers from the drawback that a user must lift the log onto the supports. For a large log, this will require two or more people. The user must then pull the chain against the bias of the spring to apply tension to the chain. This takes a large amount of strength and there is therefore a risk that the chain would be under tensioned. Furthermore, when the chain is held at tension, it is particularly awkward to pass the chain over the peg to secure the logs.

It is also undesirable to use a spring to hold the logs because when logs are being cut by a chainsaw, if the chainsaw becomes stuck in a log, the spring could extend as force is applied on the chainsaw causing the log, chainsaw and holder to move in an unpredictable manner. Consequently, if a chainsaw becomes stuck in a log, there is a potential risk of injury to a user.

Similar log holders to that of DEG8433785 are described in EP01393919, DEG8033275, AU564410 and U.S. Pat. No. 3,661,378. None of the log holders described in these documents are self adjusting and require a log to be lifted onto the respective supports. Furthermore, none of the strapping means provided by these apparatuses are self adjusting and require tensioning by various mechanical means.

Preferred embodiments of the present invention seek to overcome the above disadvantages of the prior art.

According to an aspect of the present invention, there is provided a log holder for holding a log, tree or other piece of wood in a raised position above the ground to enable the log, tree or other piece of wood to be cut into pieces, the log holder comprising:

a support member arranged to provide a fulcrum on which a log can be supported and about which the log can be pivoted;

stop means adapted to adjustably secure strap means, the strap means being adapted to wrap in a loop around a log to hold the log in a cantilevered position between the strap means and the support member, wherein the stop means is adapted to enable the size of a loop of the strap means wrapped around a log resting on the support means to be decreased but not increased.

This provides the advantage of a holder for a tree, log or other piece of wood that is straightforward to operate and does not require any adjustment to hold different sizes of log or piece of wood. In order to support a log on the holder in a raised position in which the log is cantilevered between a strap means and the support member, the log is rested on the support member and then the strap means is looped over the log. Lifting the end of the log which is in contact with the ground causes the log to pivot about the support member and be held in a raised position because the stop means enables the loop to decrease in size to grip the log but not increase in size.

The interaction between the strap means and stop means also provides the advantage that the log holder is self-adjusting to accommodate logs of different size. For a smaller log, the strap means merely self-adjusts to form a smaller loop.

This also provides the advantage that since there is no vertical aperture in which a log must fit, as in the apparatus of EP1085966, larger and shorter logs having large diameter can be held by the log holder.

In a preferred embodiment, pivoting a part of the log about the fulcrum in a first rotational direction towards the stop means causes the size of a loop of the strap means wrapped around a log resting on the support means to decrease, and wherein subsequent pivoting of the log in a second rotational direction about the fulcrum opposite to the first rotational is prevented by the stop means preventing the size of the loop of the strap means wrapped around a log from increasing to cause the log to be held in a cantilevered position between the strap means and support member.

This provides the advantage that the user is only required to lift one end of the log to cause the log to be held in a cantilevered position between the strap means and support member. The user is not required to adjust the strap means or stop means which are entirely self adjusting. This simplifies use of the log holder for a user and means that two people are not required to lift the log and adjust the parts of the apparatus that hold the log.

In a preferred embodiment, the stop means is arranged to permit movement of the strap means in a first direction through the stop means but prevent movement of the strap means in a second direction opposite to the first direction through the stop means such that when the strap means is wrapped in a loop around a log resting on the support means and threaded through the stop means such that pivoting the log about the fulcrum in the first rotational direction causes the strap means to move through the stop means in the first direction, subsequently pivoting the log about the fulcrum in a second rotational direction opposite to the first rotational direction causes the stop means to prevent movement of the strap means in the second direction through the stop means to cause the log to be held in a cantilevered position between the strap means and support member.

This provides the advantage that the user is only required to lift one end of the log to cause the log to be held in a cantilevered position between the strap means and support member. The strap means can only move freely through the stop means in one direction only, which facilitates the adjustment of loop size to hold the log.

In a preferred embodiment, the stop means comprises at least one tubular guide portion sized to permit slidable movement of the strap means therethrough in the first direction, and wherein the at least one tubular guide portion further comprises a slot arranged to engage with a recess of the strap means to prevent movement of the strap means through the at least one tubular guide portion in the second direction.

The tubular part of the guide portion aids movement of the strap means therethrough. This also provides the advantage of a stop means that is easy to manufacture from readily available materials.

In a preferred embodiment, the stop means comprises two tubular guide portions arranged in a mutually inclined configuration and having respective slots to enable the stop means to receive first and second ends of the strap means.

In a preferred embodiment, the support member comprises at least one V-shaped bracket assembly.

This provides the advantage of providing a fulcrum about which a log can pivot. Also, the interaction between the v-shaped bracket assembly and loop formed by the strap means helps to prevent left and right movement of a log held in the holder.

At least one said V-shaped bracket assembly may comprise a plurality of teeth arranged to grip a log.

This provides the advantage of enabling the log to be held more securely.

The log holder may further comprise at least one foot comprising a spike arranged to be sunk into the ground or a rubberised pad adapted to absorb vibration.

At least one foot comprising a spike provides the advantage of securing the log holder to the ground for example if the log holder is used outdoors on a forest floor. The or each spike can penetrate the ground to provide grip and prevent lateral movement or lifting of the log holder when using heavy trees or logs.

At least one foot comprising a rubberised pad provides the advantage that if the log holder is used on a hard, flat surface, vibrations produced during cutting of the log with a chainsaw will be partially absorbed by the or each rubberised foot to help prevent movement of the log holder.

At least one threaded hole may be formed in the log holder into which at least one said foot can be screwed.

This provides the advantage that the rubberised feet or spikes can be interchangeable to make the log holder more versatile.

The log holder may comprise a foldable frame.

This provides the advantage of aiding transport and storage of the log holder.

The log holder may further comprise a tree clamp to enable the log holder to be clamped to a tree trunk.

In a preferred embodiment, the tree clamp comprises a bracket having:

at least one first tooth having a first cutting edge arranged to grip a tree trunk; and

at least one second tooth having a second cutting edge arranged to grip the tree trunk;

wherein the at least one first tooth is disposed at a location on the bracket remote from the at least one second tooth and wherein the respective first and second cutting edges point in opposite directions to prevent rotation of the bracket in a predetermined rotational direction when the at least one first and second teeth grip the tree trunk.

This provides the advantage of a clamp for mounting the log holder to a tree which counteracts the torque applied on the log holder when it is holding a log in a cantilevered condition.

In a preferred embodiment, the bracket further comprises a first plurality of teeth having respective first cutting edges and a second plurality of teeth having respective second cutting edges and wherein the first plurality of teeth are disposed at a location on the bracket remote from the location of the second plurality of teeth to prevent rotation of the bracket in a predetermined rotational direction when at least some of the first and second pluralities of teeth grip the tree trunk.

This provides the advantage of providing increased grip, particularly for larger log holders.

The bracket may further comprise first and second attachment portions disposed at opposite ends of the bracket for respective attachment to biasing means to enable the at least one first and second teeth to be biased against a tree to secure the bracket to a tree.

The first and second attachment portions may comprise slots arranged to receive a length of chain or hold a hook or eye.

This provides the advantage of a mechanism for adjusting tension. By selecting which link of a length of chain is inserted into the slot or hook, the tension of the tree clamp can be adjusted for different sizes of tree trunk and other uprights such as telegraph poles.

The bracket may be elongate and comprise a central portion and first and second arms extending from the central portion, wherein the first and second arms are shaped to at least partially wrap around a circumference of a tree.

The first and second arms may extend at obtuse angles from the central portion.

The log holder may further comprise a plurality of tree clamps mounted to the frame and arranged to be clamped at different locations along a tree trunk.

This provides the advantage of a more secure clamp, particularly for larger logs and log holders.

According to another aspect of the present invention, there is provided a log holder assembly comprising a log holder as defined above; and

strap means arranged to hold a log.

In a preferred embodiment, the strap means further comprises a plurality of recessed portions arranged along the length of the strap means to enable ratcheting movement of the strap means through the stop means and wherein the stop means prevents movement of the strap means in a second direction through the stop means by engagement between a portion of the stop means and at least one recessed portion of the strap means.

This provides the advantage of a ratchet mechanism produced by the interaction of the stop means and the strap means.

The strap means comprises a chain.

This provides the advantage that the assembly is simple to repair if the strap means becomes damaged because chain is readily available. Use of a chain is also safer than use of a spring as in some prior art holders.

A stirrup may be mounted to at least one end of the chain.

This provides the advantage of enabling a user to increase the tension applied by the chain to a log or logs in the holder by virtue of enabling the user to apply a downward force on the chain with his or her foot.

According to a further aspect of the present invention, there is provided stop means comprising at least one tubular guide portion sized to permit slidable movement of strap means therethrough in a first direction, wherein the at least one tubular guide portion further comprises a slot arranged to engage with a recess of the strap means to prevent movement of the strap means through the at least one tubular guide portion in the second direction.

In a preferred embodiment, the stop means further comprises two tubular guide portions arranged in a mutually inclined configuration and having respective slots to enable the stop means to receive first and second ends of the strap means.

According to a further aspect of the present invention, there is provided a stop assembly comprising stop means as defined above and strap means comprising a chain.

A preferred embodiment of the present invention will now be described, by way of example only and not in any limitative sense with reference to the accompanying drawings in which:

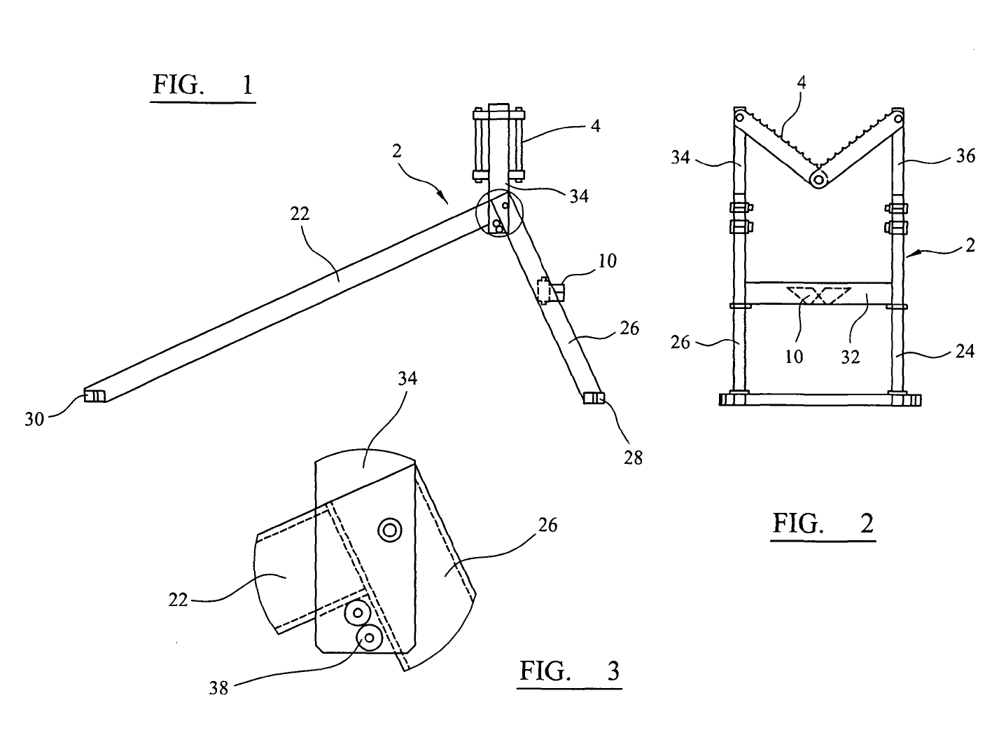

FIG. 1 is a side view of a log holder of a first embodiment of the present invention;

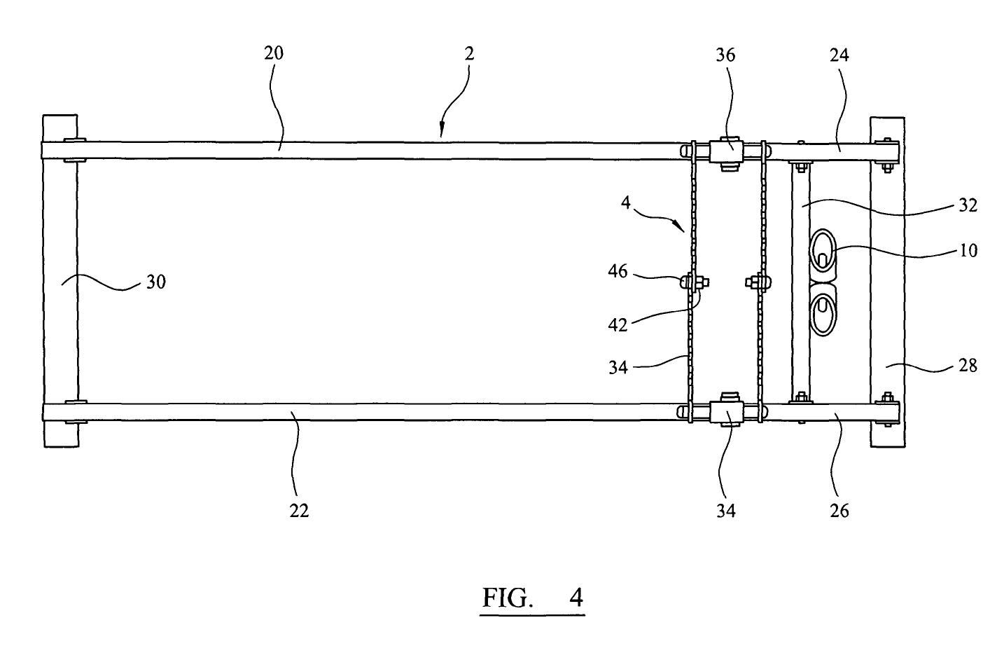

FIG. 2 is a front view of the log holder of FIG. 1;

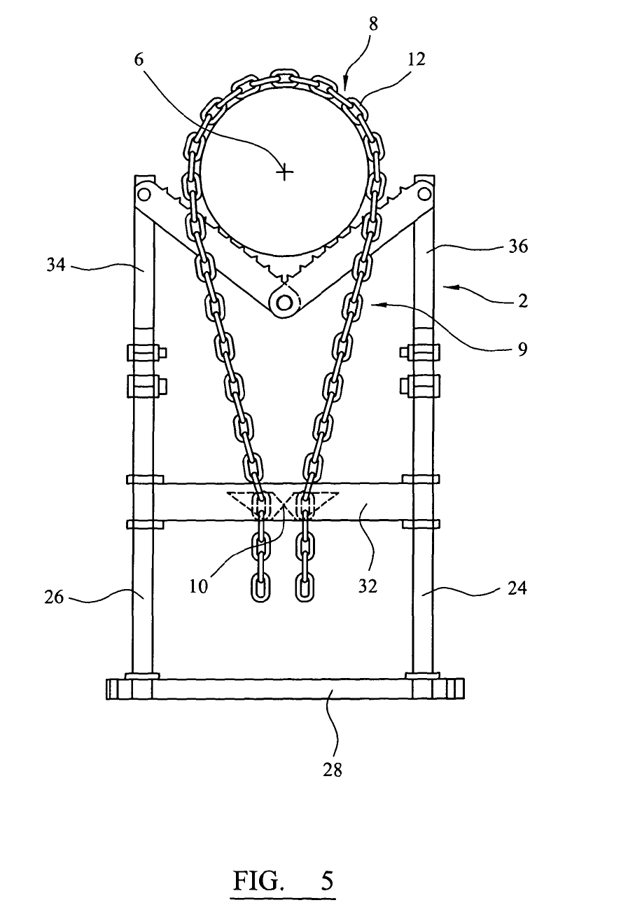

FIG. 3 is a close-up detail of the interconnection between the short leg, long leg and upright of the log holder of FIG. 1;

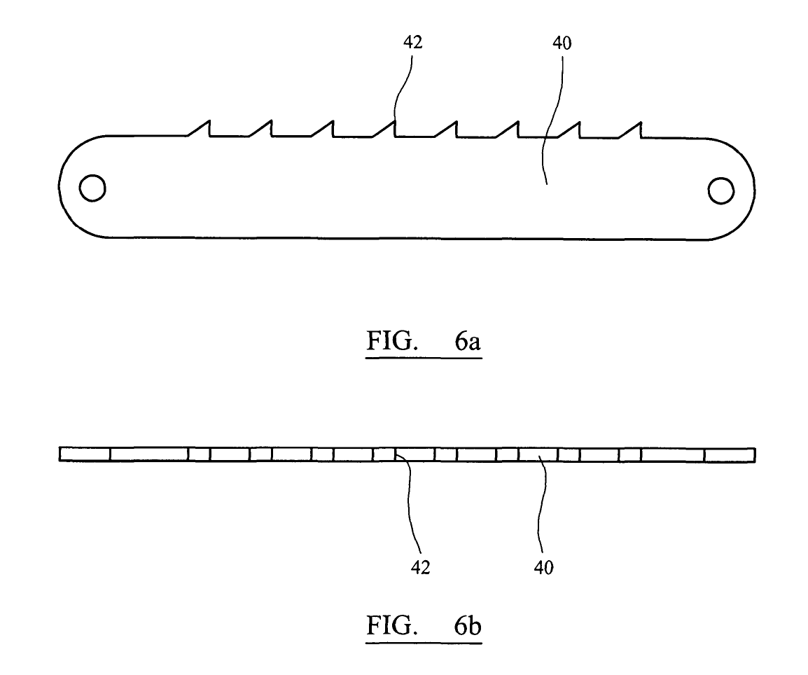

FIG. 4 is a top view of the log holder of FIG. 1;

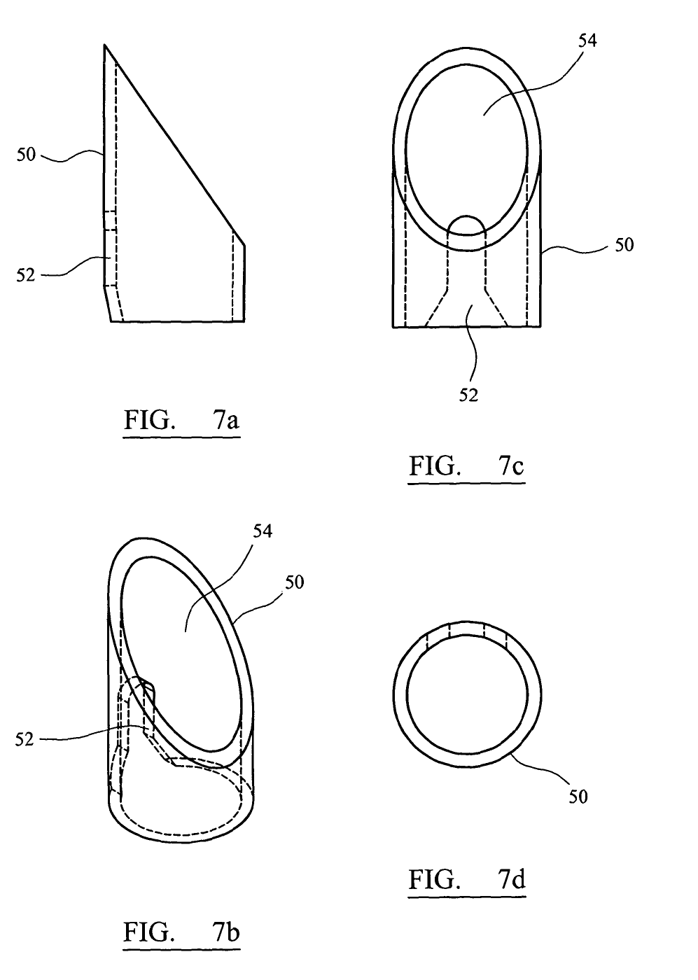

FIG. 5 is a front view of the log holder of FIG. 1 shown holding a log with a strap means such as a chain;

FIG. 6A is a side view of a plate used to form the support member;

FIG. 6B is a top view of the plate of FIG. 6A;

FIG. 7A is a cross sectional view of a chain stop used to form the stop means;

FIG. 7B is a perspective view of the chain stop of FIG. 7A;

FIG. 7C is a front view of the chain stop of FIG. 7A;

FIG. 7D is a top view of the chain stop of FIG. 7A;

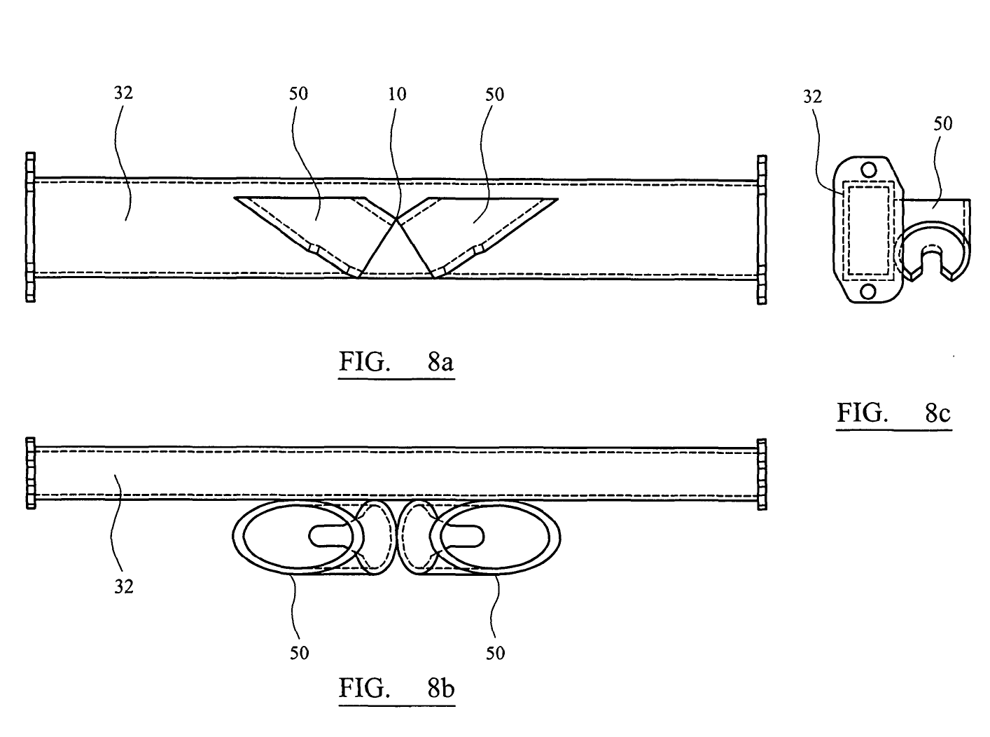

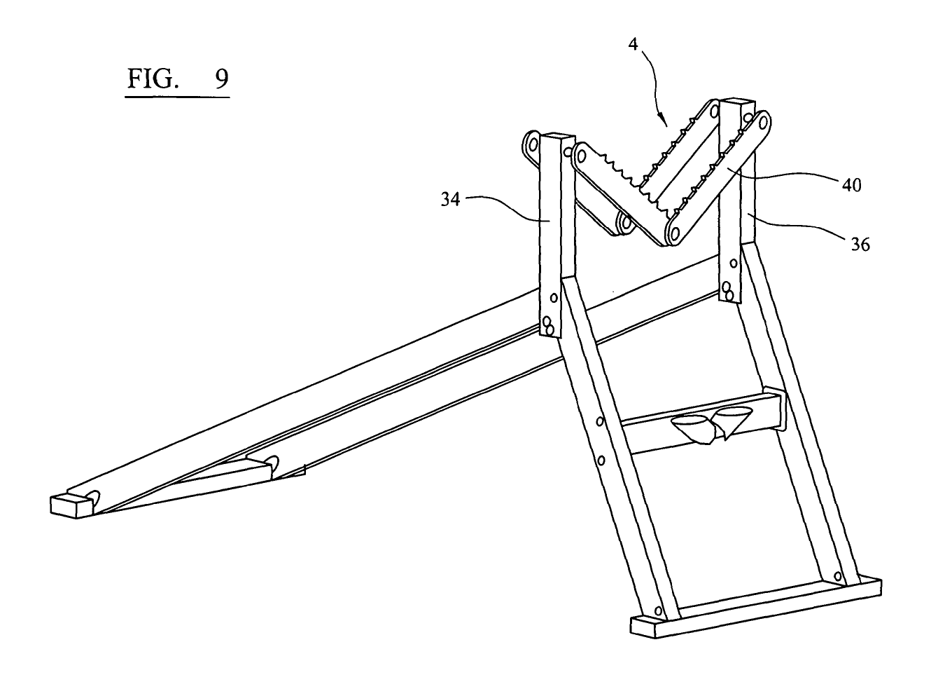

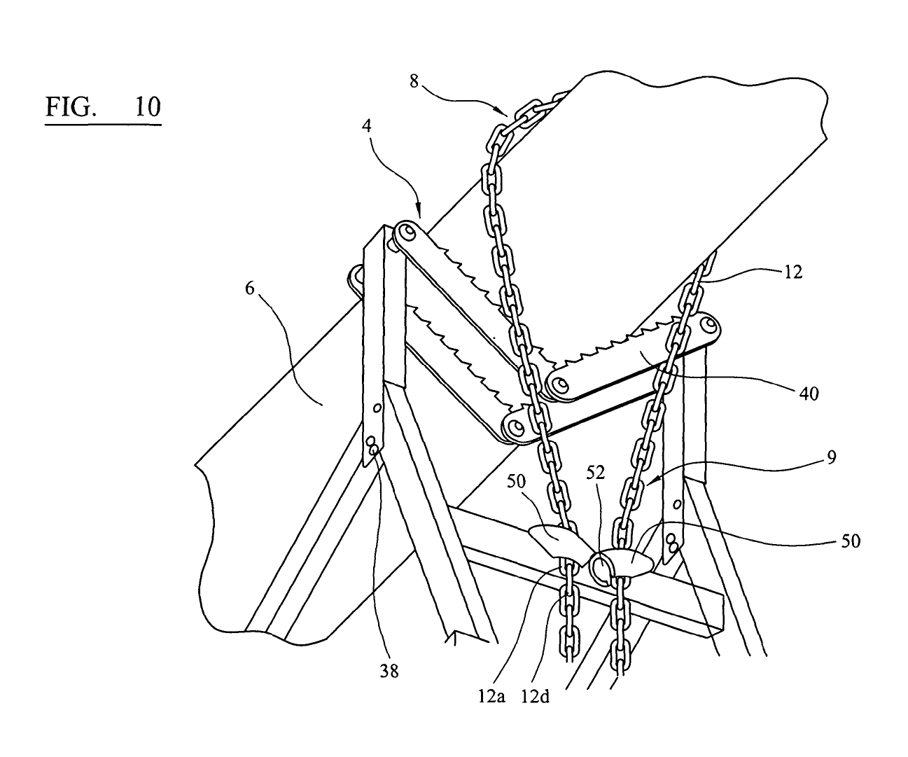

FIG. 8A is a front view of a brace on which the stop means is mounted and formed from two of the chain stops of FIG. 7;

FIG. 8B is a top view of the assembly of FIG. 8A;

FIG. 8C is a side view of the assembly of FIG. 8A;

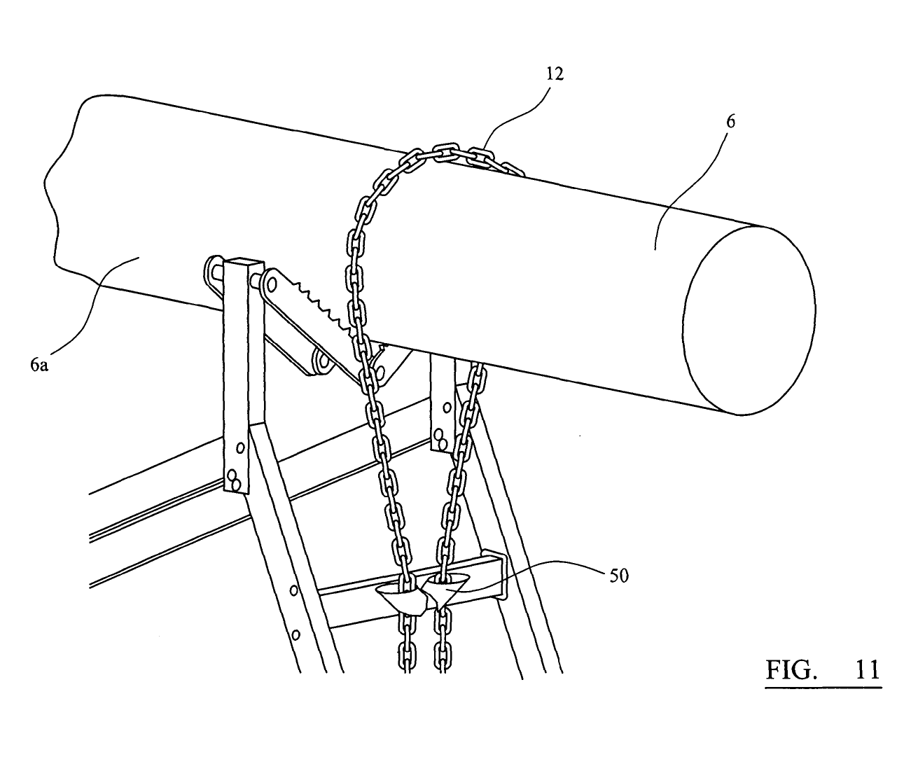

FIG. 9 is a perspective view of the log holder of FIG. 1;

FIG. 10 is a perspective view from below of a first stage of mounting a log on the log holder of FIG. 1;

FIG. 11 is a perspective view from the side of the second stage of mounting a log on the log holder of FIG. 1;

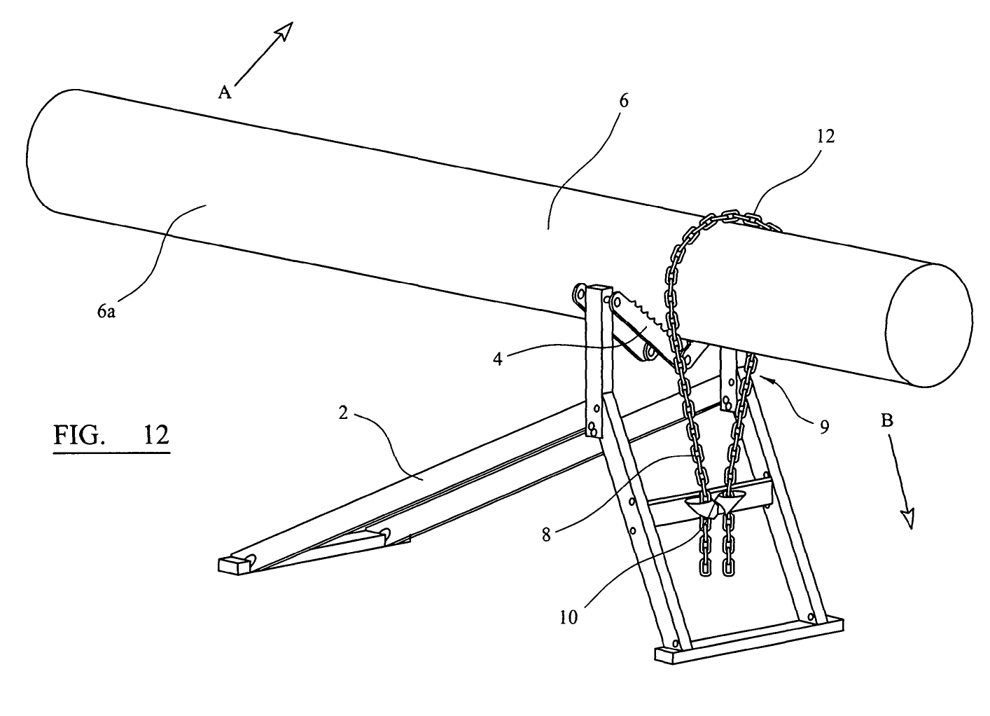

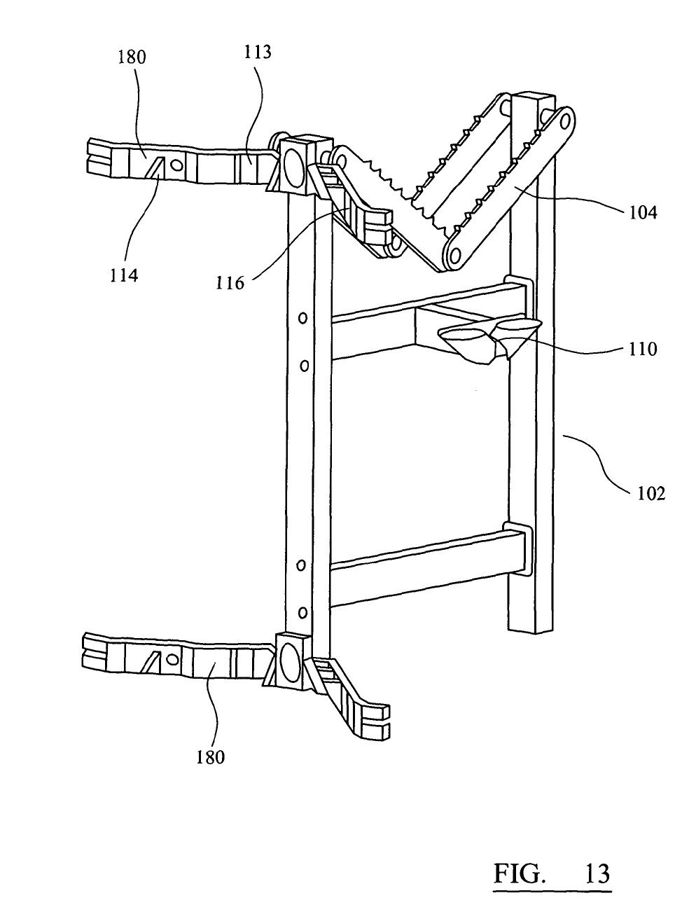

FIG. 12 is a perspective view of a log shown mounted on the log holder of FIG. 1;

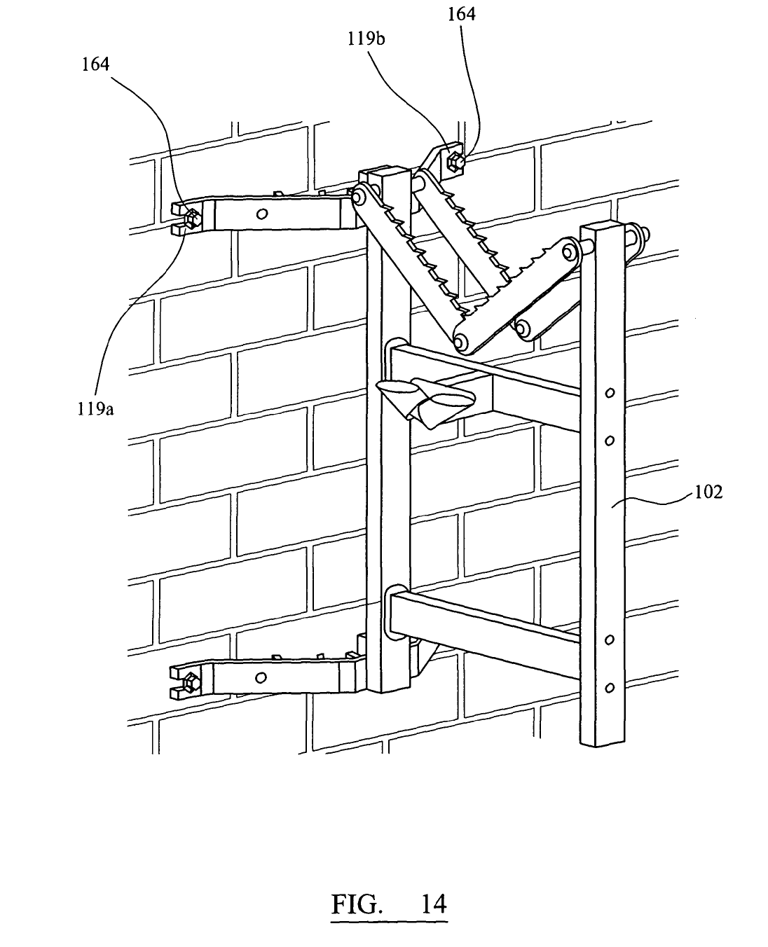

FIG. 13 is a perspective view of a log holder of a second embodiment of the present invention mounted to a pair of tree clamps;

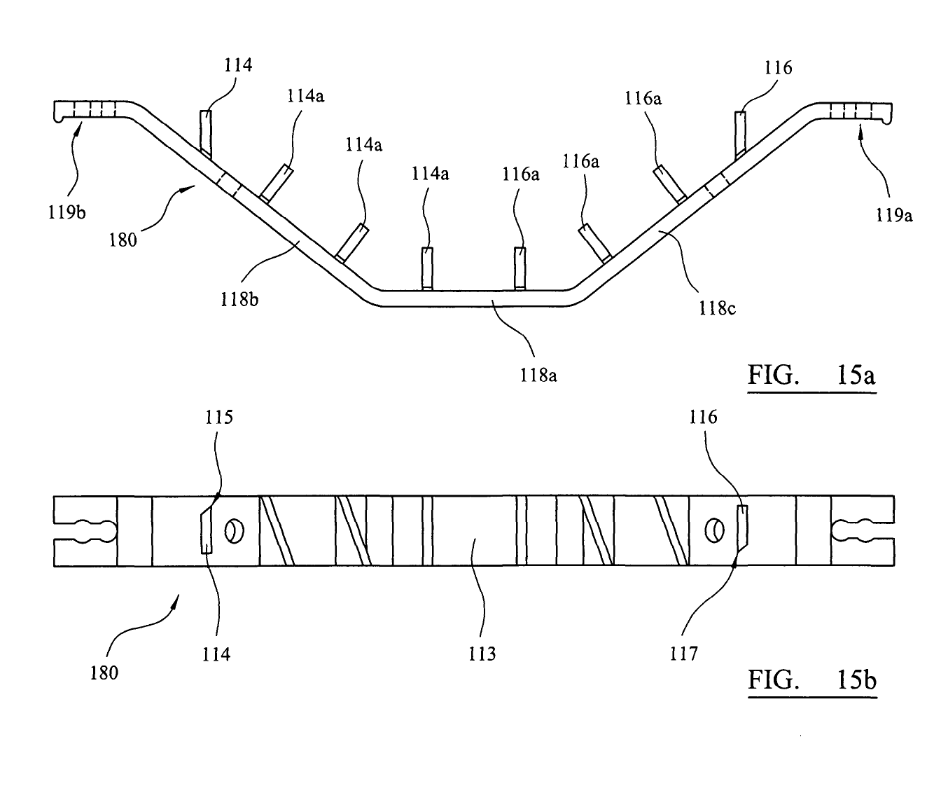

FIG. 14 is a perspective view of the log holder of FIG. 13 mounted to a wall;

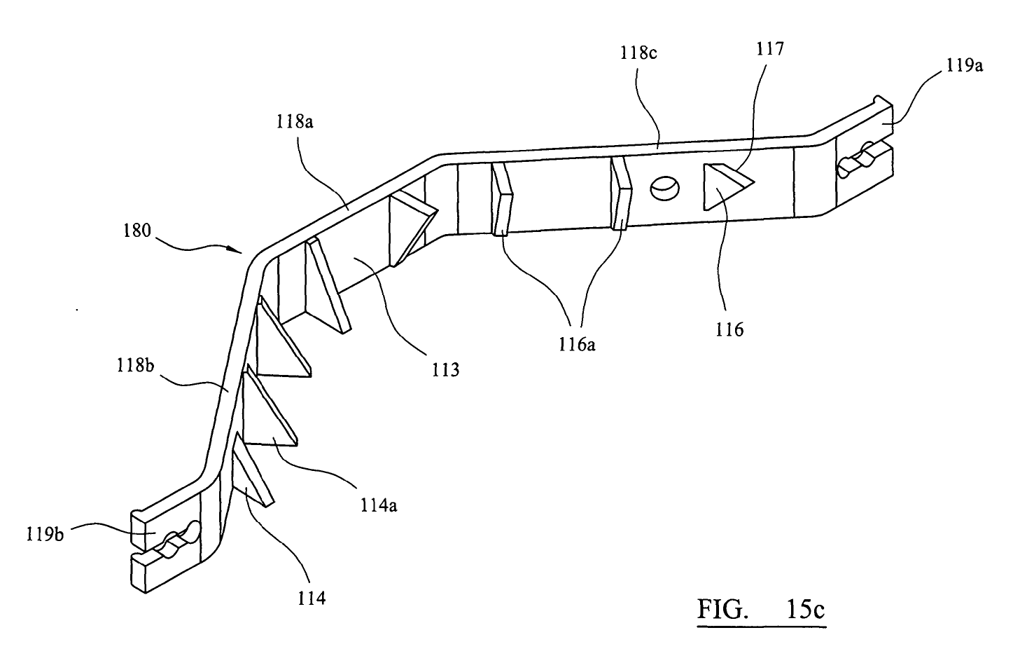

FIG. 15A is a top view of a tree clamp of FIG. 13;

FIG. 15B is a side view of the tree clamp of FIG. 15A;

FIG. 15C is a perspective view of the tree clamp of FIG. 15A;

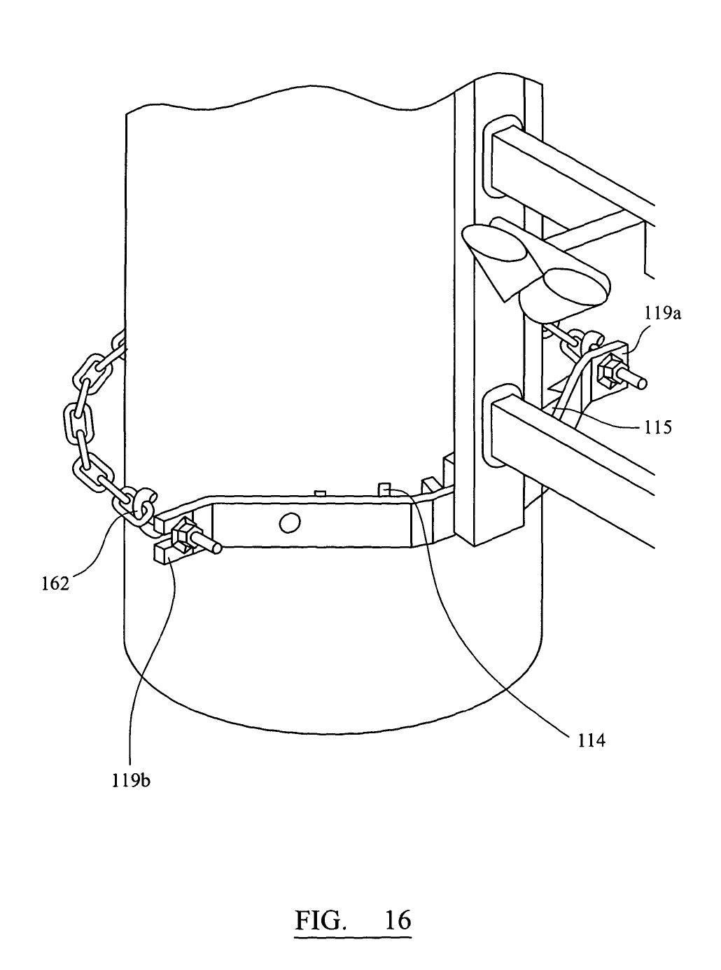

FIG. 16 is a perspective close-up view of a tree clamp mounted to a tree;

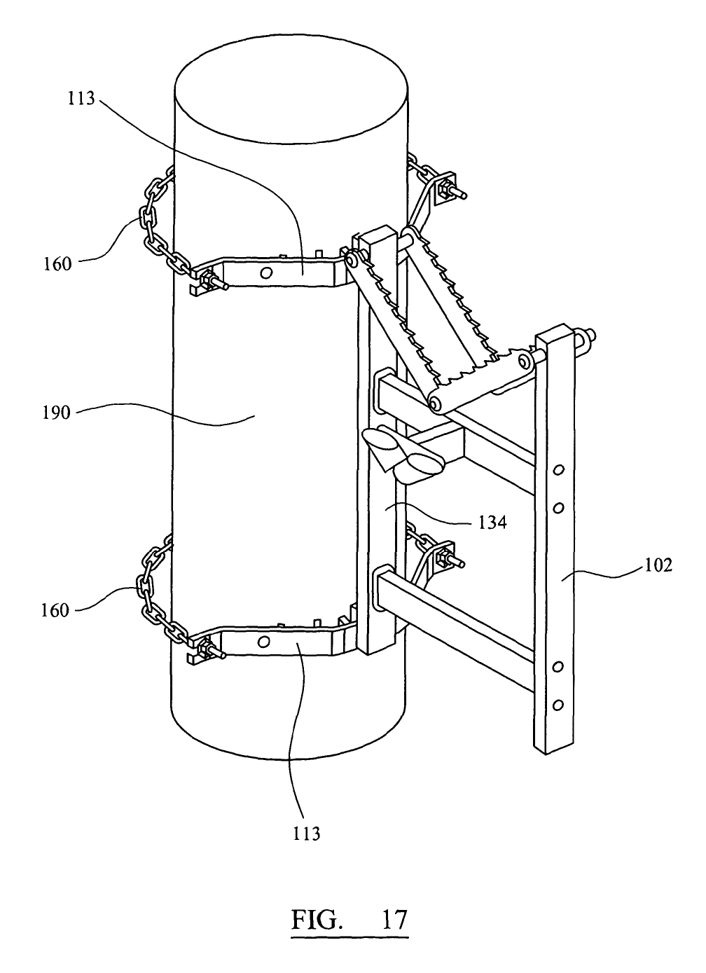

FIG. 17 is a perspective view of the log holder mounted to a tree;

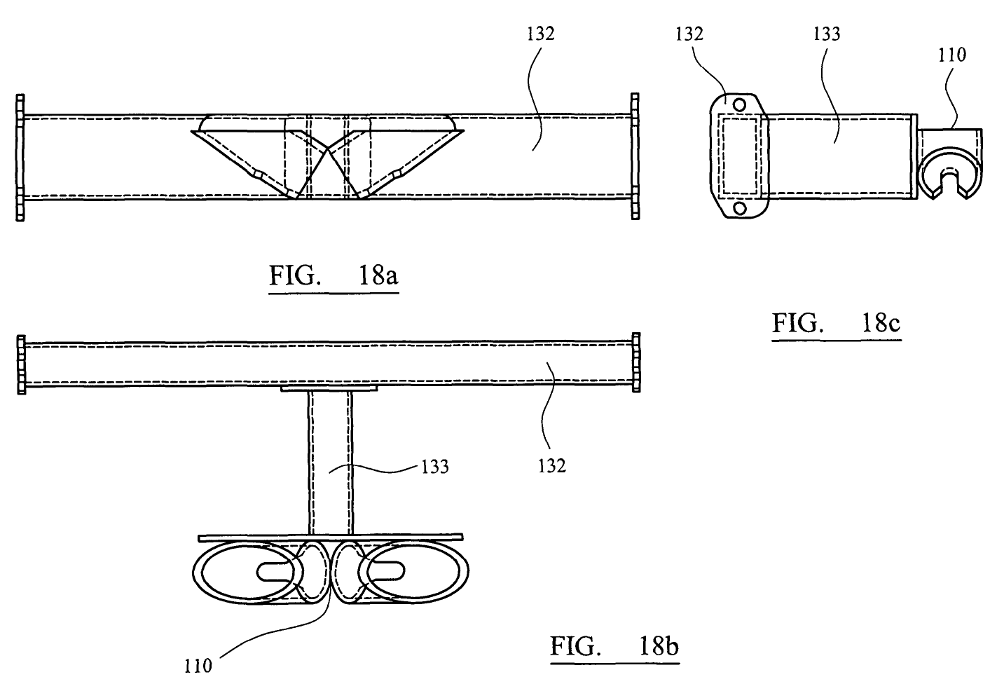

FIG. 18A is a front view of the stop means of the log holder of FIG. 13;

FIG. 18B is a top view of the assembly of FIG. 18A;

FIG. 18C is a side view of the assembly of FIG. 18A;

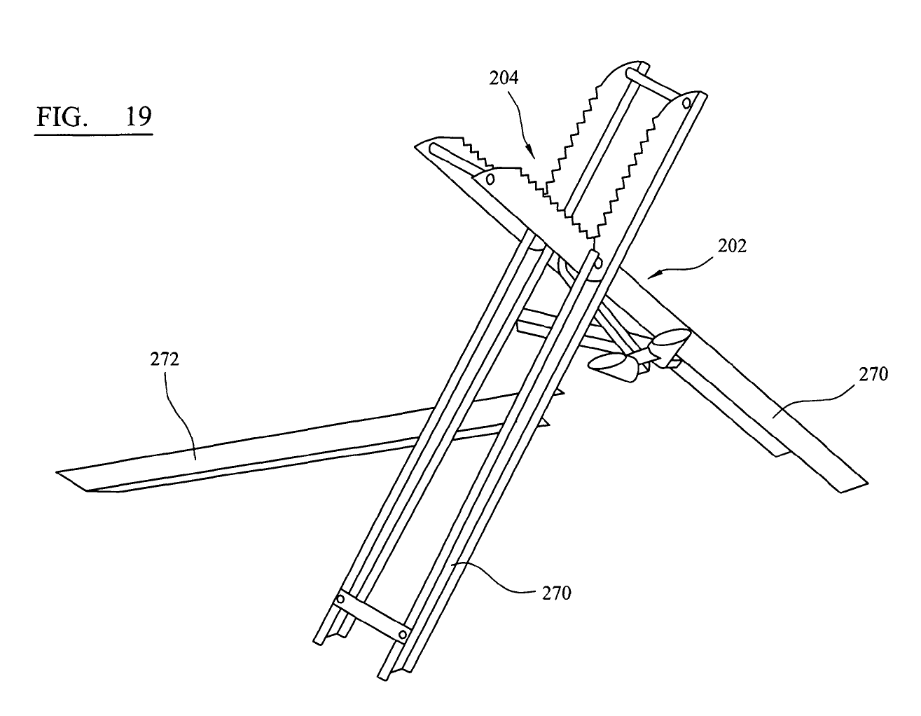

FIG. 19 is a perspective view of a log holder of a third embodiment of the present invention;

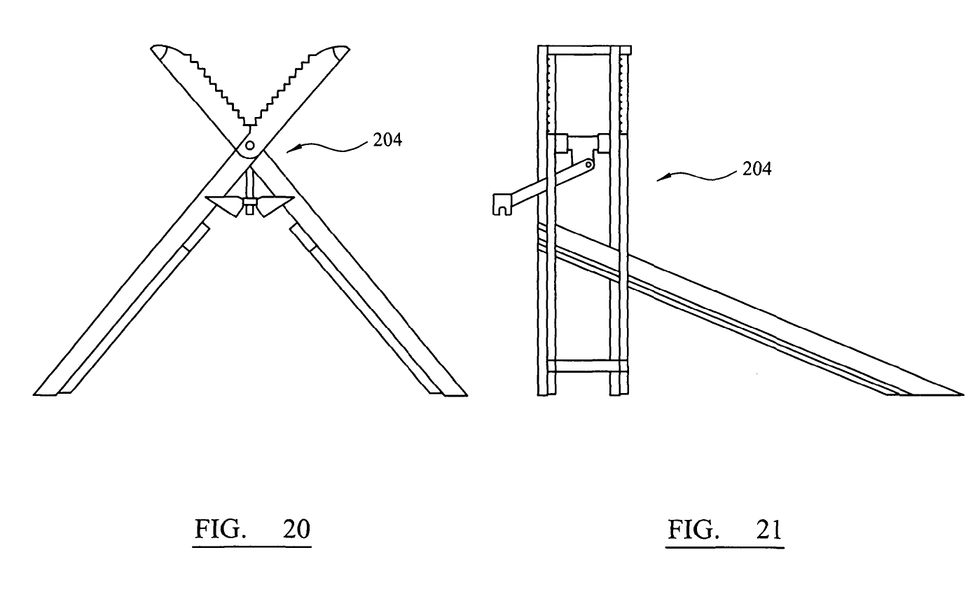

FIG. 20 is a front view of the log holder of FIG. 19;

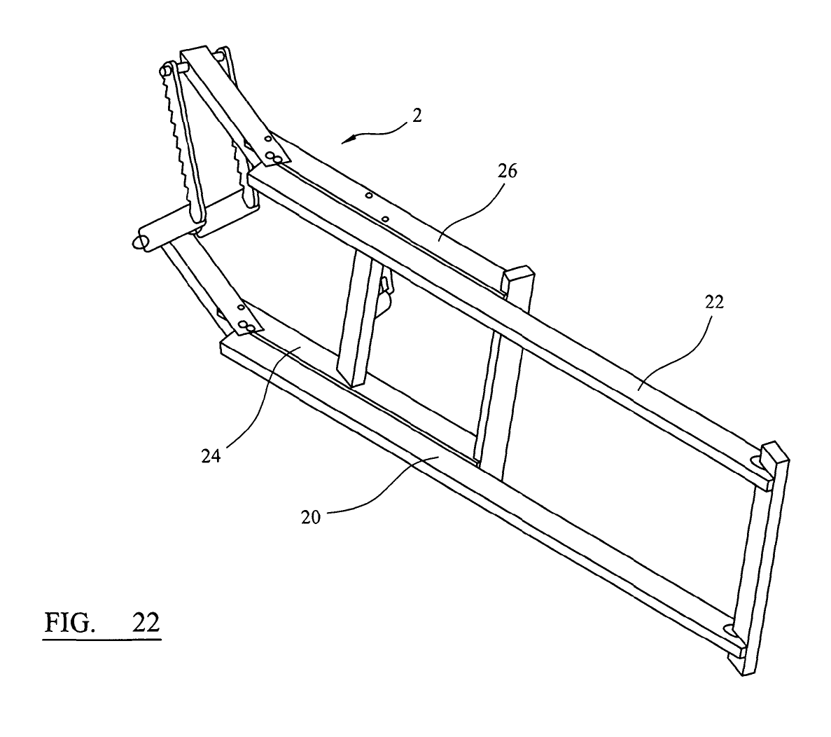

FIG. 21 is a side view of the log holder of FIG. 19;

FIG. 22 is a perspective view of the log holder of FIG. 1 in a folded condition for transport and storage;

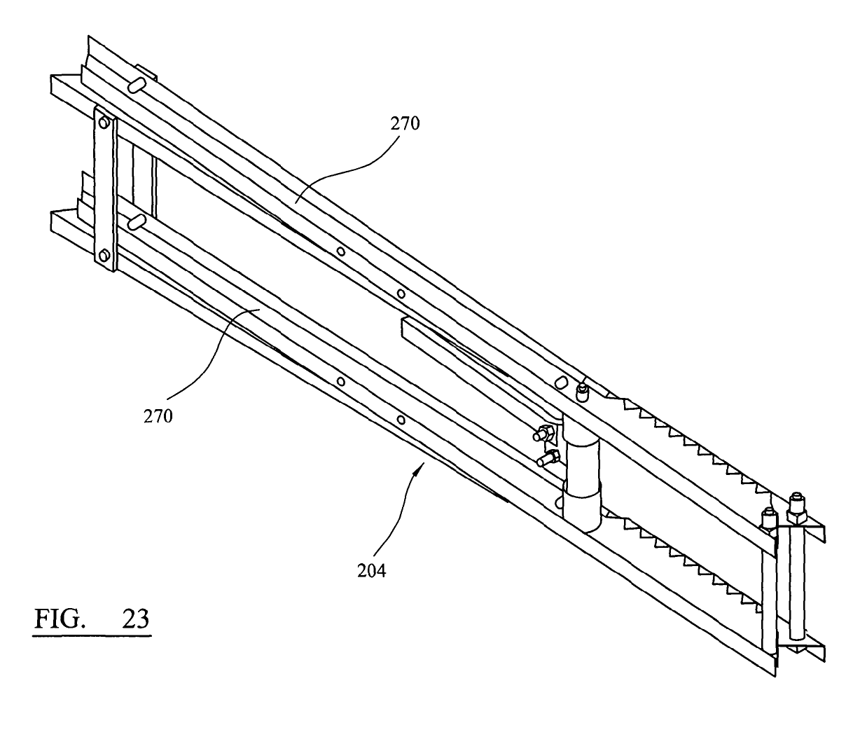

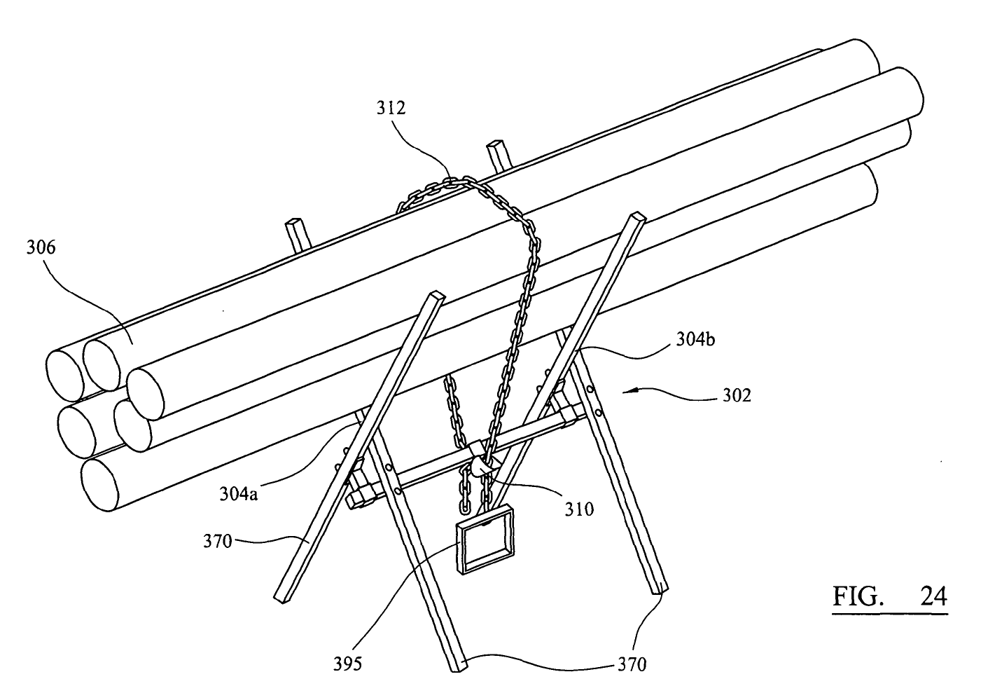

FIG. 23 is a perspective view of the log holder of FIG. 19 in a folded condition for transport and storage; and

FIG. 24 is a perspective view of a log holder of a fourth embodiment of the present invention.

Referring to FIGS. 1 to 5, a log holder 2 of a first embodiment of the present invention is shown. The log holder 2 is adapted to hold a log 6 in a raised position above the ground to enable the log to be cut into pieces. The log holder 2 comprises a support member 4 arranged to provide a fulcrum on which a log can be supported and about which the log can be pivoted.

The log holder 2 also comprises stop means 10 adapted to adjustably secure a strap means 8, the strap means 8 being adapted to wrap in a loop 9 around a log 6 to hold the log in a cantilevered position (FIG. 12) between the strap means 8 and the support member 4. The stop means 10 is adapted to enable the size of the loop 9 of the strap means 8 wrapped around a log resting on the support means to be decreased but not increased.

For example, pivoting a part of the log 6 around which the strap means 8 is wrapped about the fulcrum in a first rotational direction (arrows A and B in FIG. 10) towards the stop means 10 causes the size of the loop 9 of the strap means 8 wrapped around a log resting on the support means 10 to decrease. It should be noted that the loop does not have to wrap entirely around the log, it is an open loop that engages the log along a portion of the surface of the log. Subsequent pivoting of the log 6 in a second rotational direction about the fulcrum opposite to the first rotational is prevented by the stop means 10 preventing the size of the loop 9 of the strap means 8 wrapped around a log from increasing to cause the log to be held in a cantilevered position between the strap means and support member.

In a preferred embodiment, this is accomplished by the stop means 10 being arranged to permit movement of strap means 8 (FIGS. 5 and 10) in a first direction (downwardly in FIG. 5) through the stop means 10 but prevent movement of the strap means 8 in a second direction (upwardly in FIG. 5) opposite to the first direction through the stop means 10 such that when the strap means 8 is wrapped in a loop 9 around log 6 resting on the support means and threaded through the stop means such that pivoting the log 6 about the fulcrum in the first rotational direction causes the strap means 8 to move through the stop means 10 in the first direction, subsequently pivoting the log 6 about the fulcrum in a second rotational direction opposite to the first rotational direction causes the stop means 10 to prevent movement of the strap means 8 in the second direction through the stop means 10 to cause the log 6 to be held in a cantilevered position between the strap means 8 and support member 4. Alternatively, preventing the size of loop formed by the strap means from increasing could be accomplished by using an inertia reel belt similar to a car seat belt as strap means.

The log holder 2 comprises a frame formed from a pair of long legs 20 and 22, a pair of short legs 24 and 26, and first and second feet 28 and 30 to which the respective pairs of long and short legs are connected. At least one foot comprising a spike (not shown) arranged to be sunk into the ground or a rubberised pad (not shown) adapted to absorb vibration can be mounted to edges of feet 28 and 30. At least one threaded hole (not shown) can be formed in the log holder into which the feet can be screwed. This enables the type of foot in use to be interchanged.

A brace 32 is mounted between the pair of short legs 24 and 26 to provide a structure on which to mount the stop means 10. A pair of uprights 34 and 36 is mounted to the frame to provide a structure between which the support member 4 can be mounted. The frame is foldable as shown in FIG. 22 to facilitate transport and storage of the log holder.

Referring to FIG. 3, the pivotable interconnection between long leg 22, short leg 26 and upright 34 is shown. This enables folding of the frame as shown in FIG. 22. All of the parts of the frame are formed from generally rectangular metal tubing and a pair of bolts 38 passing through the tubing of upright 34 forms the connection. This can be best seen in FIG. 10.

Referring to FIGS. 4, 5, 6 and 9, the support member 4 is formed from four plates 40 connected together with suitable fasteners such as nut 42 and bolt 46 in a dual V-shaped configuration which is mounted to uprights 34 and 26. This provides two V-shaped bracket assemblies, although a single V-shaped bracket assembly could be used if required. Furthermore, other shapes rather than a V-shaped configuration for the support member can be used on the condition that whatever the shape of the support member, it can provide a fulcrum on which a log can be supported and about which the log can be pivoted. A plurality of teeth 42 extend from the upper edge of each bracket 40. The teeth provide grip to the log when being pivoted, although the support member will also function without the teeth.

Referring to FIGS. 5 and 10, the strap means 8 comprises a length of chain 12. This enables the strap means to comprise a plurality of recessed portions which are formed by the alternatively directed links of the chain. Although the preferred embodiment is the use of a length of chain 12 as the strap means 8, any generally deformable elongate member comprising a plurality of recessed portions along the length could also be used. Furthermore, it could be possible to use a length of rubber tubing since the tube can deform in the stop means 10. Alternatively, an inertia reel belt could be used.

Referring to FIGS. 7A to 7D, the stop means comprises at least one tubular guide portion 50 sized to permit slidable movement of the strap means 8 through the tubular guide portion. Each tubular guide portion 50 further comprises a slot 52 arranged to engage with a link of the chain 12 to prevent movement of the chain through the aperture in one direction.

For example, referring to FIG. 10, chain 12 can easily be threaded downwardly (i.e. in the first direction) under its own weight through the tubular guide portion 50 by virtue of running along the inclined inner surface 54 of the tubular guide portion 50. However, when the chain is pulled upwardly (i.e. in the second direction) a first link 12a of chain 12 sits in slot 52, but a second link 12b of chain 12, which is orientated at a right angle to the first link 12a abuts against the edges of slot 52a and the outer surface of the tubular guide portion 50 to prevent upward movement of the chain 12 through the tubular guide portion 50. This happens in both tubular guide portions 50 in FIG. 10, preventing upward movement of both the first and second ends of the chain 12.

Referring to FIGS. 8A to 8C, two tubular guide portions 50 are mounted in a mutually inclined arrangement to brace 32. This configuration enables the stop means 10 to be conveniently located in front of support member 4. Alternatively, a single guide portion could be used if the strap means is secured to the log holder at one end.

Referring to FIGS. 10 to 12, the method of mounting a log or piece of wood to be cut in the log holder of the first embodiment of the present invention will now be described. It should be understood that the log holder can be used to hold felled trees, logs from which branches have been removed and other lengths of wood.

Referring to FIG. 10, a log 6 is rested against the support member 4. In practice this comprises resting one end of the log on the ground and laying the log against the V-shaped bracket formed by plates 40. With one end of the log resting on the ground, the user then passes chain 12 over the top of the log and threads the ends of the chain 12 respectively through tubular guide portions 50. Once the ends of the chain 12 are threaded through the respective tubular guide portions 50, the user does not have to touch the chain 12 again.

The next step is to pivot the end of the log that is resting on the floor upwardly in the direction of arrow A such that the opposite end of the log pivots downwardly in the direction of arrow B about the fulcrum provided by the support member 4. This causes the ends of chain 12 to drop downwardly through tubular guide members 50. The chain 12 runs freely through tubular guide members 50 and does not require a user to pull the chain downwardly in the first direction.

When log 6 is raised to a substantially horizontal configuration (FIG. 11) on the log holder assembly 2, the user can let go of log 6. The moment produced by the long end 6a of log 6 causes the log to attempt to pivot in the opposite direction about fulcrum to that of arrows A and B shown in FIG. 12. However, because the chain 12 is prevented from moving in the second direction (upwardly) through the stop means 10 by virtue of engagement of respective links of chain 12b against the edges of slot 52, the chain cannot move back through the stop means 10 such that loop 9 cannot decrease in size and the log is therefore cantilevered between the chain 12 and the support member 4. The log is therefore held in a raised horizontal position above the ground and can be cut with a chainsaw.

Referring to FIGS. 13 to 18, a log holder assembly of a second embodiment of the present invention is shown with parts common to the embodiment of FIGS. 1 to 12 denoted by like reference numerals but increased by 100. Log holder assembly 102 comprises support member 104, stop means 110 and a pair of tree clamps 180.

Referring to FIGS. 13, 15A to 15C and 17, the tree clamp 180 comprises a bracket 113 having at least one first tooth 114 having a first cutting edge 115 arranged to grip a tree trunk 190 and at least one second tooth 116 having a second cutting edge 117 arranged to grip the tree trunk. The at least one first tooth 114 is disposed at a location on the bracket remote from the at least one second tooth 116 and the respective first and second cutting edges 115, 117 point in opposite directions to prevent rotation of the bracket in a predetermined rotational direction when the at least one first and second teeth grip the tree trunk.

Consequently, the tree clamp enables the torque produced by a log held in the log holder 102 to be counteracted. For example, when a log is mounted in the log holder shown in FIG. 13 with the long end of the log projecting into the page, this produces a torque in the direction of arrow C. However, upwardly directed tooth 116 and downwardly directed tooth 114 biting into a tree trunk cancel out this torque.

For smaller log holders, two teeth pointing in opposite directions would be sufficient, although as shown in the drawings, the bracket comprises a first plurality of teeth 114a having respective first cutting edges and a second plurality of teeth 116a having respective second cutting edges. The first plurality of teeth is disposed at a location on the bracket remote from the location of the second plurality of teeth. This improves grip. The bracket is elongate and comprises a central portion 118a and first 118b and second 118c arms extending from the central portion at obtuse angles. The first and second arms 118b, 118c are shaped to at least partially wrap around a circumference of a tree. Although obtuse angles used, the bracket 113 could also be curved.

First and second attachment portions 119a and 119b are disposed at opposite ends of the bracket for respective attachment to a biasing means to enable at least one said first and second teeth to be biased against a tree to secure the bracket to a tree. For example, the first and second attachment portions 119a and 119b comprise slots arranged to receive a length of chain 160. Alternatively, the attachment portions could comprise hooks 162 (FIG. 16) or eyes. This enables the force applied to the tree to be controlled by selection of a predetermined link of chain in the attachment portion. This also provides a simple way of mounting the tree clamp 180 to different sizes of tree trunk or other upright structures such as a telegraph pole.

The log holder 102 is shown attached to a tree 190 in FIGS. 16 and 17. Two brackets 113 are connected to upright 134 of the log holder 102. When a length of chain 160 is received in each end of the bracket by means of a hook, slot or eye, the respective pluralities of teeth 114 and 116 bite into the trunk of the tree and prevent rotation of the log holder when a log or piece of wood is mounted in the log holder. Mounting of a log in the log holder is accomplished in the same manner as described in connection with the embodiment of FIGS. 10 to 12 and will not be described in any further detail here.

In this embodiment the log holder assembly 102 can be readily attached to tree trunks of difference sizes by simply using different lengths of chain 160.

Referring to FIGS. 18A to 18C, in this embodiment the stop means 110 is held further out from brace 132 by an extension arm 133. This ensures correct functioning of the stop means.

Referring to FIG. 14, bracket 113 can also be attached to a wall by using respective screws 164 through attachment members 119a and 119b.

A log holder assembly of a third embodiment of the invention is shown in FIGS. 19 to 21 with parts common to the first embodiment denoted by like reference numerals but increased by 200. Log holder assembly 202 comprises a support member 204 which is formed by crossed leg portions 270. Removable leg supports 272 are also provided to stabilise the assembly. As shown in the drawing, the assembly is formed from lengths of sheet metal interconnected by suitable fasteners. This assembly is lightweight compared to the first and second embodiments and is therefore easily transportable and suitable for lighter pieces of wood and logs. Consequently, a chain of smaller link diameter can be used. The frame of log holder 202 is foldable as shown in FIG. 23 to facilitate transport and storage of the log holder.

A log holder assembly of a fourth embodiment of the invention is shown in FIG. 24 with parts common to the first embodiment denoted by like reference numerals but increased by 300.

Bulk log holder assembly 302 comprises first and second support members 304a and 304b which are formed by crossed leg portions 370. This assembly is designed to hold several logs 306 at the same time, or a single large log. In both cases, the logs can be loaded in same the manner as the other embodiments described above.

To increase the tension that can be applied by chain 312 to log 6, a stirrup 395 is mounted to an end of chain 312 to enable a user to apply downward force to the chain 312 with his or her foot to tighten chain 312. To release chain 312 a user applies a force down and towards the centre line of the holder. A stirrup could be removably mounted to one or both ends of the chain by use of a karabiner clip or a similar method.

It will be appreciated by persons skilled in the art that the above embodiments have been described by way of example only and not in any limitative sense, and that the various alterations and modifications are possible without departure from the scope of the invention as defined by the appended claims.

1. A log holder for holding a log, tree or other piece of wood in a raised position above the ground to enable the log, tree or other piece of wood to be cut into pieces, the log holder comprising:
a support member arranged to provide a fulcrum on which a log can be supported and about which the log can be pivoted;
a stop device adapted to adjustably secure a strap, the strap being adapted to wrap in a loop around a log to hold the log in a cantilevered position between the strap and the support member, wherein the stop device is adapted to enable the size of a loop of the strap wrapped around a log resting on the support member to be decreased but not increased.

2. A log holder according to claim 1, wherein pivoting a part of the log about the fulcrum in a first rotational direction towards the stop device causes the size of a loop of the strap wrapped around a log resting on the support means to decrease, and wherein subsequent pivoting of the log in a second rotational direction about the fulcrum opposite to the first rotational is prevented by the stop device preventing the size of the loop of the strap wrapped around a log from increasing to cause the log to be held in a cantilevered position between the strap and support member.

3. A log holder according to claim 2, wherein the stop device is arranged to permit movement of the strap in a first direction through the stop device but prevent movement of the strap in a second direction opposite to the first direction through the stop device such that when the strap is wrapped in a loop around a log resting on the support member and threaded through the stop device such that pivoting the log about the fulcrum in the first rotational direction causes the strap to move through the stop device in the first direction, subsequently pivoting the log about the fulcrum in a second rotational direction opposite to the first rotational direction causes the stop device to prevent movement of the strap in the second direction through the stop device to cause the log to be held in a cantilevered position between the strap device and support member.

4. A log holder according to claim 3, wherein the stop device comprises at least one tubular guide portion sized to permit slidable movement of the strap therethrough in the first direction, and wherein the at least one tubular guide portion further comprises a slot arranged to engage with a recess of the strap to prevent movement of the strap through the at least one tubular guide portion in the second direction.

5. A log holder according to claim 4, wherein the stop device comprises two tubular guide portions arranged in a mutually inclined configuration and having respective slots to enable the stop means to receive first and second ends of the strap.

6. A log holder according to claim 1, wherein the support member comprises at least one V-shaped bracket assembly.

7. A log holder according to claim 6, wherein at least one said V-shaped bracket assembly comprises a plurality of teeth arranged to grip a log.

8. A log holder according to claim 1, further comprising at least one foot comprising a spike arranged to be sunk into the ground or a rubberised pad adapted to absorb vibration.

9. A log holder according to claim 8, further comprising at least one threaded hole formed in the log holder into which at least one said foot can be screwed.

10. A log holder according to claim 1, wherein the log holder comprises a foldable frame.

11. A log holder according to claim 1, further comprising a tree clamp to enable the log holder to be clamped to a tree trunk.

12. A log holder according to claim 11, wherein the tree clamp comprises a bracket having:
at least one first tooth having a first cutting edge arranged to grip a tree trunk; and
at least one second tooth having a second cutting edge arranged to grip the tree trunk;
wherein the at least one first tooth is disposed at a location on the bracket remote from the at least one second tooth and wherein the respective first and second cutting edges point in opposite directions to prevent rotation of the bracket in a predetermined rotational direction when the at least one first and second teeth grip the tree trunk.

13. A log holder according to claim 12, wherein the bracket further comprises a first plurality of teeth having respective first cutting edges and a second plurality of teeth having respective second cutting edges and wherein the first plurality of teeth are disposed at a location on the bracket remote from the location of the second plurality of teeth to prevent rotation of the bracket in a predetermined rotational direction when at least some of the first and second pluralities of teeth grip the tree trunk.

14. A log holder according to claim 12, further comprising first and second attachment portions disposed at opposite ends of the bracket for respective attachment to a biasing device to enable the at least one first and second teeth to be biased against a tree to secure the bracket to a tree.

15. A log holder according to claim 14, wherein the first and second attachment portions comprise slots arranged to receive a length of chain or hold a hook or eye.

16. A log holder according to claim 12, wherein the bracket is elongate and comprises a central portion and first and second arms extending from the central portion, wherein the first and second arms are shaped to at least partially wrap around a circumference of a tree.

17. A log holder according to claim 16, wherein the first and second arms extend at obtuse angles from the central portion.

18. A log holder according to claim 12, further comprising a plurality of tree clamps mounted to the frame and arranged to be clamped at different locations along a tree trunk.

19. (canceled)

20. A log holder assembly comprising a log holder according to claim 1; and
a strap arranged to hold a log.

21. An assembly according to claim 20, wherein the strap further comprises a plurality of recessed portions arranged along the length of the strap to enable ratcheting movement of the strap through the stop device and wherein the stop device prevents movement of the strap in a second direction through the stop device by engagement between a portion of the stop device and at least one recessed portion of the strap.

22. An assembly according to claim 21, wherein the strap comprises a chain.

23. An assembly according to claim 22, further comprising a stirrup mounted to at least one end of the chain.

24. A stop device comprising at least one tubular guide portion sized to permit slidable movement of strap therethrough in a first direction, wherein the at least one tubular guide portion further comprises a slot arranged to engage with a recess of the strap to prevent movement of the strap through the at least one tubular guide portion in a second direction.

25. A stop device according to claim 24, further comprising two tubular guide portions arranged in a mutually inclined configuration and having respective slots to enable the stop device to receive first and second ends of the strap.

26. A stop assembly comprising a stop device according to claim 25 and a strap comprising a chain.
